(19) United States
(12) Patent Application Publication
(10) Pub. No.: US 2017/0205801 A1
(43) Pub. Date: Jul. 20, 2017

(54) METHOD AND SYSTEM FOR AUTOMATIC MANUFACTURING OF CUSTOM FIT GARMENTS

(71) Applicant: Lab 141, Inc., Brooklyn, NY (US)

(72) Inventors: Philip J. Manning, Syracuse, NY (US); Geeta Andrea Madho, Brooklyn, NY (US)

(73) Assignee: Lab 141, Inc., Brooklyn, NY (US)

(21) Appl. No.: 15/378,505

(22) Filed: Dec. 14, 2016

Related U.S. Application Data
(60) Provisional application No. 62/266,824, filed on Dec. 14, 2015.

(51) Int. Cl. G05B 19/402

(52) U.S. Cl. CPC G05B 19/402; G05B 2219/45222

(57) ABSTRACT

A system and method is disclosed for the creation of made-to-measure items based on specific fit preferences. In one embodiment, the Customer selects a garment Design, decides how they want the garment to fit, and then uses the Fiteema™ or Fiteemo™ proprietary fit-garment technology to measure those fit preferences. The selected garment is then re-dimensioned using the Manning Process™ Harmonizing stage and then each component required to make the garment is cut out.

### PRIORITY

This is a nonprovisional utility application, which claims priority to U.S. Provisional Patent Application No. 62/266,824, filed on Dec. 14, 2015, which is hereby incorporated by reference in its entirety for all that it teaches.

### BACKGROUND OF THE INVENTION

There is a complex relationship between Consumers, Fashion Brands/Designers, Manufacturers and Retailers. The Customer not only wants a garment that fits, but in a Brand that they like. Retailers know that a Customer who comes into their establishment is much more likely to make other purchases, so that the loss of a customer coming in is potentially the loss of many accessory or other product sales. Retailers also understand if too much of an item is ordered in the wrong size or color, it is subject to automatic markdown which reduces their profitability and can cause damage to the Brand/Designer. Mass Manufacturers are very good at manufacturing one particular item in mass quantities very quickly and efficiently, but are not adept at low volume, let alone graded ‘one offs’ or made-to-measure. The pain point at the top of this retail hierarchy is the customer not finding the item they want that fits them. Many clothing options available to the retail customer are mass produced in limited sizes based off a standardized geometric sizing system that does not account for all the different variations in human beings' sizes, shapes, body types, and proportions. Customers who want superior fit can visit a tailor for a made-to-order item, but there are a number of issues with the solution that lead to various forms of consumer dissatisfaction. There is a great need in the market for alternative access to customized clothing that is individually sized according to a specific person's measurements. The Manning Process™ of this invention addresses all these issues.

### BRIEF SUMMARY OF THE INVENTION

The Lab141 Manning Process™ disclosed in this invention consists of 4 separate steps whose purpose is the creation of made-to-measure items, which may be a clothing garment or any other kind of product comprised of cut fabric pieces that are sewn or otherwise attached together along their edges, based on individual fit preferences that are automatically detected and cataloged for each application, whether fitting a person or an object. In one embodiment, a customer selects a design (which is based on a garment pattern imported or digitized through the Transcribing™ operation which is step two of the Manning Process™). The customer decides how they want the garment to fit by using the Lab141 Fiteema™ proprietary fit-garment technology further explained below. The proprietary Harrmonizer™ system combines fit preference from Fiteema™ with the digitized patterns from the Transcriber™ operation to re dimension the pattern to perfectly fit the expectations of the individual. Each fabric component required to make the garment is cut out and marked using the Lab141 Vesti™ cutting table. Assembly of the garment by sewing the customized fabric components into a wearable finished product may then be accomplished by ordinary methods.

This is unlike any know sizing system in the world. Current methods of fitting garments are based on averages and typical body types. Designers also currently rely on live fit models to determine clothing fit for their standardized size to be graded, mass produced and sold.

### BRIEF DESCRIPTION OF THE DRAWINGS

FIG. 1: Shows one embodiment of a Fiteema™ worn by a woman.

FIG. 2: Shows one embodiment of a body strap that is incorporated in a Fiteema™ or Fiteemo™.

FIG. 3: Shows another embodiment of a body strap that is incorporated in a Fiteema™ or Fiteemo™.

FIG. 4: Shows a clothing pattern for use in the Transcribing™ stage.

FIG. 5: Shows a clothing pattern for use in the Transcribing™ stage with measurement points starting to be labeled.

FIG. 6: Shows a clothing pattern for use in the Transcribing™ stage with the location of measurement points and lines labeled.

FIG. 7: Shows a detail of a clothing pattern with data points labeled for mathematically defining a curve in the pattern.

FIG. 8: Shows the current geometric scaling sizing system that is commonly used in the clothing and garment industry.

FIG. 9: Shows The Manning Process™ sizing and dimension system for clothing.

FIG. 10: Shows a detail of one embodiment of a Fiteema™ or Fiteemo™ with sensors located at the waist to record coordinates and calculate the garment waist measurement.

FIG. 11: Shows a detail of one embodiment of a digitized clothing pattern displaying waist measurements on the pattern.

FIG. 12: Flowchart for one embodiment of the invention.

FIG. 13: Shows an example garment pattern taped down and with points labeled.

FIG. 14: Shows a portion of an excel chart listing coordinates for points on a garment.

FIG. 15: Shows a drawing of coordinate points to be used to confirm measurements are accurate.

FIG. 16: Shows another view of an excel chart, showing coordinate points, a drawing, and Entity types defined from this data.

FIG. 17: Shows a view of a table containing Point data for garments.

FIG. 18: Shows a view of data for a table containing Point data for garments.

FIG. 19: Shows another view of a table containing Point data for garments.

FIG. 20: A front view of the Fiteema measurement device.

FIG. 21: A rear view of the Fiteema measurement device.

### DETAILED DESCRIPTION OF THE INVENTION

Glossary:

Cutting line: the path on the pattern that the cutting toolhead (laser, rotary wheel or drag knife) follows to cut the fabric.

Entity: an entity refers to an object for the pattern, that comprise the garment components. Some entities are visually apparent as part of the pattern, for example LineTypes that are a ‘line’, ‘curve’, ‘dart’, ‘seam’ or ‘cut’. The cut is the line the cutting wheel cuts on which is calculated as the seam allowance that is added to the dimension of where the seam is. In the invention other entities are construction lines, that is, they are dimensions mathematically determined by the geometry of the pattern. Examples of entity that may be construction lines are, waist, rise, inseam, cuff, bustline, waist-to-neck, waist-to-knee line, waist to armpit, center-back. An entity may be a cut line that is the border of the component, the seam line where the component is sewn to the neighboring component, a dart, where the component folded and sewn.

Garment Pattern: All the garment components that make up a particular garment and all its options (such as ‘neck’ pattern component, or ‘sleeve’ pattern component).

Garment component: One of the many pieces that make up a finished garment.

Multiplicative Matrix Inverse: A mathematical method for solving multiple equations with multiple unknowns.

Points: Points are the x and y positions on a Cartesian coordinate system and are either the beginning and ending of a straight line, or locations on a curve. A Cartesian system is used since the Vacuum table control is based on Cartesian values. If a Polar system was used for digitizing, a polar system could be employed for cutting.

Line: A “Line” can only be either ‘straight’ or ‘curved’. A straight line can be defined with only two points (a beginning and an end). A curved line requires the calculation of the equation of the curve, so the more points on the curve the better, however using a dot Matrix process we generate the equation with just a beginning, ending and three other points arbitrarily located on the curve. The process is detailed in this paper.

Line Type: A “Line Type” is a parameter of an entity and defines a lines purpose. A Line Type can only be either ‘Sewing line’, ‘Dart’ or ‘Cut line’. The sewing line is the line that is sewn on to join pieces of the garment together. The sewing line can either be straight or curved. A Dart is the line that shows how the pattern is to be sewn on to allow the fabric to fit around curves. For our purposes, the dart line can only be a straight line, which probably represents 99% of the darts currently used in all garments. While it is possible to have a curved dart, this software will not allow it. The cut line is the line that the cutting wheel will follow and cut on. This can either be curved or straight and is exactly like the sewing line only offset the amount of fabric for a seam allowance.

Matrix: A mathematical array of values.

Microscribe: A piece of hardware generally used in the graphic arts industry for the recording of Cartesian coordinates in an X, Y, Z plane.

Sewing line: This is the path that a tailor will follow with a sewing machine to join pieces of the garment together.

Quadratic Equation: As applied here, a mathematical expression that defines a curve using three constants and a single variable of exponent 2.

The Lab141 Manning Process™ consists of 4 stages which can be used together or independently for the creation of made-to-measure items, including clothing.

Stage One employs the use of a Lab141 Fiteema™ for women, or Fiteemo™ for men fit-garment (The terms Fiteema™ and Fiteemo™ may be used throughout this specification interchangeably for convenience, but such usage should in no way be used to construe or limit the disclosure to apply to such fit-garments only for men or as only for women.) The Fiteema™/Fiteemo™ is a fabric-based measuring device mimicking a dress or other clothing item, with adjustable sensors to record fit preferences for further use in creating a made-to-measure garment. The sensors may be adjusted in a variety of ways, for example, by the customer, the retailer, third parties, or based on pre-set metrics. The output of Fiteema™/Fiteemo™ is an ID value which is data that represents the customer's specific fit preference and is referred to as the “SNIP” (Selected desigN Identifier Profile).

Stage Two consists of the Lab141 Transcriber™, which is the importing of a brand/company's specific garment pattern for a particular style, (i.e. BrandX, style 3749) in to the Lab141 Manning Process™.

Stage Three consists of Lab141 Harmonizer™, which is the action of applying software technology to traditional patternmaking techniques to alter and adjust a the Digitized Design to a particular Customer's SNIP™. The Harmonizing™ stage uses the SNIP™ generated in stage one, and Digitized Design from stage two, together to map and generate G-code as output to be used by the Vesti™ cutting table for further marking and cutting of fabric into the component fabric pieces that can be assembled to form the garment. It is known in the art that G-code refers to commands that control computer controlled manufacturing equipment. In this invention, the G-code output from the Harmonizer™ controls the cutting of the fabric to manufacture the garment components and mark the seams and dart lines. In addition to the standard G-code used to control the Cutting wheel, a User defined, G-code will cause the equipment to imprint on each component a unique identifier so that the piece of fabric may be identified and using the data in the computer system associated with the customer and the garment the customer seeks to modify. In one embodiment the marks imprinted on the fabric are human readable identifiers. In another embodiment, they are computer scannable identifiers, for example, bar codes. In the preferred embodiment, the markings are made on what will be the interior side of the garment component or on the fabric in between the seam and the cut line. The system is configured so that a bar-code can be read off of a garment component and the customer and style being customized can be identified, however it is anticipated that various fabric patterns may be such that the barcode reading process is highly unreliable, therefore both a human readable and barcode pattern will be printed in an effort to reduce possible errors.

Stage Four consists of Lab141 Vesti™, the cutting and marking table, which in the preferred embodiment is a modular vacuum assisted CNC cutting table that is controlled via standard G-code generated from the Lab141 Dimensioning stage. Other hold down methods, such as applying an electro-static charge to the material being cut and grounding the cutting surface may also be employed. Vesti's functionality includes the ability to receive G-code for further cutting and marking fabric. In another embodiment of the invention, the cutting table has the further capability to serge fabrics, and sew garments itself. The output from Vesti™ are the customized and individually cut and marked fashion components ready for sewing. (electrostatic).

### Stage One: Fiteema™/Fiteemo™

In the current art, if a customer wants a made-to-measure garment, they go to a tailor, select a pattern and have their measurements physically taken. The tailor takes a pattern that they have used in the past and modifies it so that waist, chest, sleeve length, etc. to correspond to the customer's measurements and then they cut out and assemble the garment. The Customer will usually come in for a fitting, they express their preferences of how they want the garment to fit and the tailor will make the adjustments, which hopefully are relatively minor. When the tailor is done, the Consumer comes back in, hopefully the garment is to their satisfaction and the transaction is completed. There are several issues with this process that can cause Consumer dissatisfaction.
1. Measurement skill level variations: The person doing the measurements has to be fairly skilled. Large alterations required due to poor measurement collection may make the garment useless or can damage the fabric. If additional alterations are needed, this can also waste time, create delay and lead to customer frustration.
2. Communication: The Consumer must be able to clearly communicate what they want in terms of fit and the Tailor must be able to clearly understand their needs. The situation is further complicated if the Consumer and tailor are trying to communicate in a language other than their native tongue or using terminology unfamiliar to each other. Misunderstandings in communication or mistranslation can lead to construction of a garment that is not in line with the customer's wants, needs, or fit preferences.
3. Standard pattern: The pattern that the tailor works from is usually a pattern that has been graded and then individual changes are made. For example, if a woman is approximately a traditional size 12, the tailor will attempt to modify the size 12 pattern. If the Consumer has a shorter torso a complete redesign of the pattern would have to be done. For this reason, sometimes the fit of custom made clothing is less than desirable.
4. Subjectivity: Every tailor has formed an opinion of what the perfect fit is. This may or may not align with the consumer's opinions and expectations. For example, an older or more conservative tailor may believe that a pant leg should fit loosely, while a younger or less conservative tailor may desire a more form fitting pant leg.
5. Inconvenience: The consumer has to physically go to the shop at least twice (more if the alterations were not correct). This is considered a hardship, time consuming, and is not practical.
6. Sewing skill level variations: The Consumer does not always get the predictable quality they are familiar with if they buy a name brand garment. This is because many name brands in the garment industry rely on various licensees to manufacture different product types or lines—so while the final name brand is consistent, the actual source of construction and manufacture can be wildly varied. Predictability plays a huge role in consumer spending and helps to explain the success of fast food chains whose quality may not be high, but the product matches the consumer's expectations.
7. Lack of Brand: Unless the tailor is known to the masses, the Consumer still is unable to purchase and support the brand that they like and can relate to. Some consumers purchase brand name clothing because certain status symbols attached to that product line; by wearing brand name clothing, the customer is able to communicate their social class or desired social class to the public. Purchasing made to order clothing from a local tailor can come with social stigma because it typically lacks that publicly recognizable brand or status symbols.

In one embodiment, the Lab141 Fiteema™/Fiteemo™ fit-garment is a propriety fabric-based measuring device that one wears over or under their clothes which mimics a dress, skirt, shirt, pants, jacket or other clothing item. Sensors are embedded in the fit-garment in order to detect and record a Customer's fit preferences and these detected fit preferences and data describing customer information are stored in a computer for further use in creating the made-to-measure garment. In one embodiment, the ID Value is an alpha numeric string that is the combination of the customer info, where the Fiteema process was performed (e.g. the retail store), the date they had the Fiteema done and the readings from all of the sensors on the Fiteema device. In one embodiment, theses values are all to be concatenated into a single value of at least 21 characters. In alternative embodiments, the Fiteema device in combination with its controlling computer can store each sensor output individually as a set of data records associated with a unique identifier associated with the customer. The data records would include reference to the garment style being fitted.

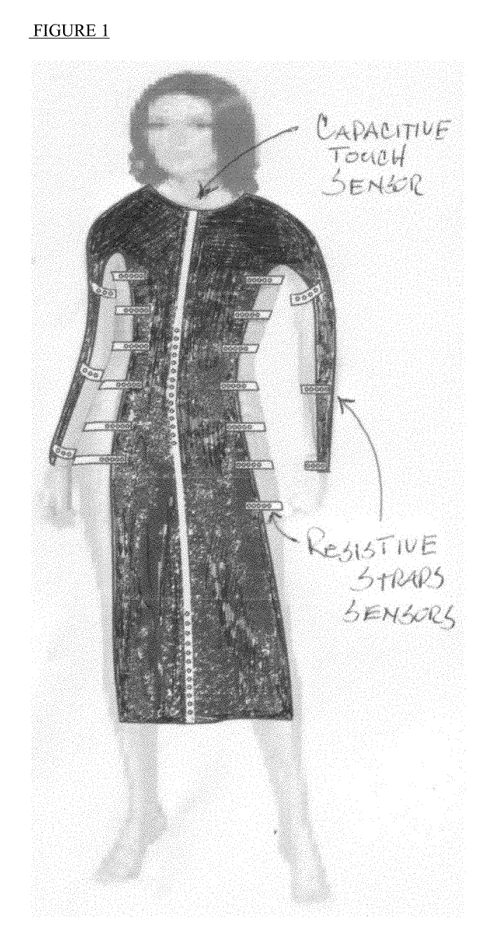

In one embodiment, the Fiteema™/Fiteemo™ will record at least 3 different types of data: horizontal, vertical and drape. Standard horizontal measurements (shoulder, waist, hips, bust, etc.) can be taken by adjusting magnetic straps located on the Fiteema garment at the places where the measurement is to be made and recording the distance representing the desired fit for that measurement. In one embodiment, the detector is comprised of a series of resistors in a series circuit that are integrated into a strap (typical of many) which is permanently attached to the back of the Fiteema garment at the place of measurement. In this embodiment each resistor has a contact point on the front of the fit-garment that has a conductive contact that, when engaged, completes the circuit. The resistance of the entire circuit is an electrical measure of which fit point on the strap was selected. If resistors with different ohm values were used such that the resistive total of all of the straps gave a unique value, then a single resistive total could be used which would uniquely represent the position of each of all the straps. The measurement is corresponds to the electrical resistance through each strap (see FIG. 1). Vertical measurements (shoulder to waist, etc.) can be recorded via capacitive touch fabric where the Customer could simply touch a location (say on the front of the garment) to record the position of for example their waist. Drape can be measured via triple axis gyroscope sensors located on the back of the garment. Inputs can be measured with an analog-to-digital converter, that uses the resistance (or resultant voltage) to generate an analog signal that is then stored as a converted digital value in a microcomputer that controls the Fiteema device. In one embodiment, the controller is an Arduino microprocessor. In another embodiment, the straps may be made of a resistive fabric, such as a conductive rubber. In this embodiment, a relatively continuous function of fit measurement to resistance is accomplished. In one embodiment the number of inputs required to the microcontroller exceeds the number of inputs available on the Arduino, in which case a multiplexor can be used. The number of inputs required is reduced by using resistors in each strap such that the resistive strap positions available for a given strap results in a unique range of resistance. For example, one strap may be represented by 10 to 100 Ohms, while another 1000 to 10000 Ohms. The microcontroller can detect the entire range, and therefore, will be able to determine that two measurements are contained in a measurement of 1100 Ohms resistance, i.e. 100 Ohms from the first strap and 1000 from the second. However, in another embodiment, each strap can have the same range of resistance values, and the microcontroller can separately address each sensor using an analog multiplexor. In yet another embodiment, each strap has its own analog-to-digital circuit, where the digital side of the circuit is separately addressable. In this embodiment, the microprocessor simply marches through the sensor addresses are reads the measurement. In any of these embodiments, the desired fit values for each location on the customer's body is measured using an electric sensor and digital measurement values are stored in the controlling computer for later use in the customizing process.

Measuring ‘desired fit’ as opposed to actual measurements is unlike any known system in the world today. Other methods of recording physical measurements, such as 3D body scanner applications, can only provide the measurement of actual physical data--they cannot directly measure customer's preferences. Since they only can take measurements, they can only address issue number one (Measurement skill level variations:) listed above. In addition, in some applications, measuring the size of an object to be fitted cannot be accomplished because the object is already in situ and cannot be removed to be placed on a fitting stage. Therefore, the Fiteema device may also be shaped to be other than a garment, and may be in the shape of a cylinder, spheroid, or other shape that can be slid over an object, the straps tightened and the fitting measurement made.

In one embodiment, shown in FIG. 1, horizontal data is collected via resistance values record from magnetically secured straps. The opposing straps are placed around the customer's body part and secured by a magnets embedded in the opposing straps. Alternatively, a buckle, snap or other fastener may be used. In any case, the resistive circuit is closed and can be then measured. The front of the garment is attached to the back of the garment with adjustable horizontal straps approximately every 2 inches. As each strap is changed, the resistance is modified to a unique value. These resistances are recorded to represent the measurement at a given location. Vertical data is collected via a capacitive touch sensor attached to the Fiteema garment at a predetermined location, for example, one on each shoulder. In one embodiment, the capacitive touch sensor is connected by a wire to an input to an interface circuit to the microcontroller. The microcontroller can then detect the value of the capacitance at that known location on the Fiteema garment. Fabric drape is recorded via output from 3-axis gyroscopes attached at various points on the back of the Fiteema™.

### Body Strap Position

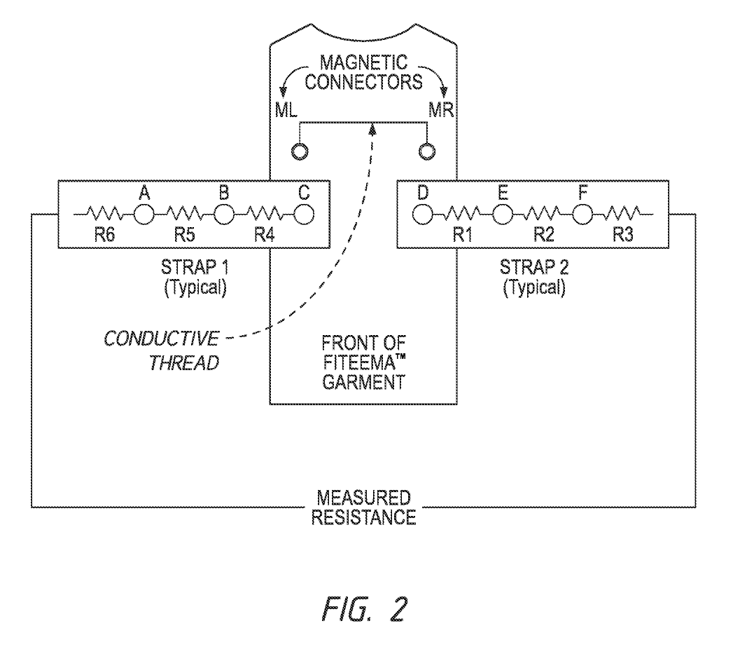

FIG. 2 shows a configuration of left/right strap combinations in one embodiment. In FIG. 2, Body Strap 1 and Strap 2 are shown. A piece of conductive thread goes from one side of the front of the fit garment to the other to complete the circuit between magnetic connectors ML (the magnetic connector on the left side) and MR (the magnetic connector on the right side). The connectors on each strap (shown as A, B, C, D, E, F) are conductive and will adhere to the magnetic connectors ML and MR. Since the resistors on each strap are unique, the measured resistance through the circuit will vary depending on which connector (A, B or C) is connected to ML and which connector (D, E or F) is connected to MR. Distance can be calculated by calculating resistance.

If all the resistors were sized so as to give unique values, the position of every strap could be determined by calculating total resistance through all straps and only one input would be required on the Arduino.

TABLE 1
Example resistor values in Body Straps

| Strap | Resistor | Value (for example only) |
|---|---|---|
| Strap 1 | R1 | 1K |
| Strap 1 | R2 | 2K |
| Strap 1 | R3 | 4K |
| Strap 2 | R4 | 10K |
| Strap 2 | R5 | 20K |
| Strap 2 | R6 | 30K |

TABLE 2
Calculated resistances for various Body Strap positions

| Left | Connected | Right | Connected | Resulting |
|---|---|---|---|---|
| Strap | at position | Strap | at position | resistance |
| 1 | A | 2 | D | R6 + R1 + R2 + |
| | | | | R3 = 37K ohms |
| 1 | A | 2 | E | R6 + R2 + R3 = |
| | | | | 36K ohms |
| 1 | A | 2 | F | R6 + R3 = |
| | | | | 34K ohms |
| 1 | B | 2 | D | R6 + R5 + R1 + |
| | | | | R2 + R3 = 57K ohms |
| 1 | B | 2 | E | R6 + R5 + R2 + |
| | | | | R3 = 56K ohms |
| 1 | B | 2 | F | R6 + R5 + R3 = |
| | | | | 54K ohms |
| 1 | C | 2 | D | R6 + R5 + R4 + |
| | | | | R1 + R2 + R3 = |
| | | | | 67K ohms |
| 1 | C | 2 | E | R6 + R5 + R4 + |
| | | | | R2 + R3 = 66K ohms |
| 1 | C | 2 | F | R6 + R5 + R4 + |
| | | | | R3 = 64K ohms |

### Arm Strap Position

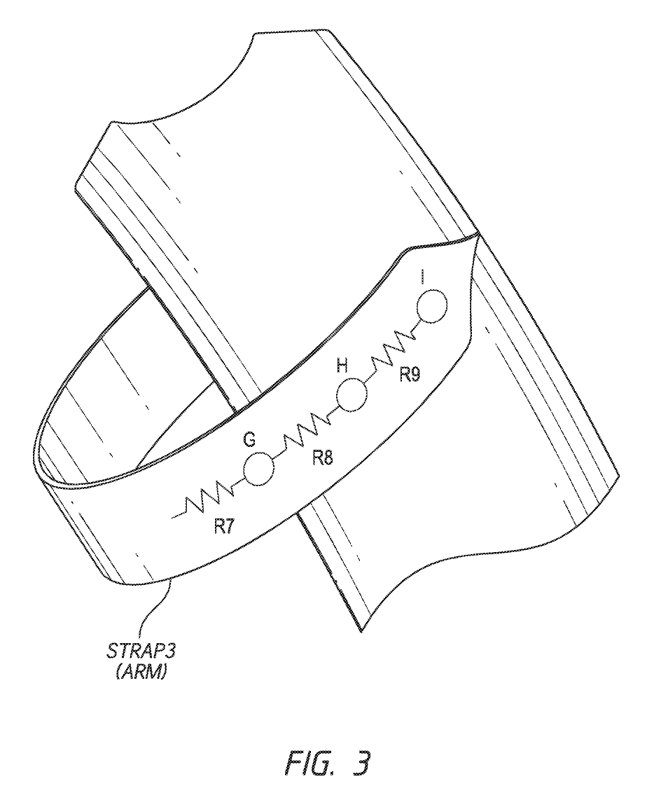

In FIG. 3, one embodiment of an Arm Strap for a Fiteema™/Fiteemo™ is shown. If position of all straps was going to be entered as a single value, the resistors would just have to be sized so that only unique values would be given. For examples, if the Left body strap was in connected in position A and the Right body strap was connected in position D and the Arm Strap #3 was connect in position G, the total resistance would be 137 ohms. This value uniquely describes the position of each of these sensors since it cannot be generated by any other series of connections.

The Capacitive Touch sensors would have an input for each and an LED to show the Customer what pad they actually touched in one embodiment. With so many inputs and outputs, a standard multiplexer circuit would then be required.

The output from the gyroscopes can be an X, Y, Z value. The gyroscopes would then be located on the back of the dress or other garment along the Customer's spine and would measure how they wanted the fabric to drape in the back of the garment.

In the preferred embodiment, there are 21 sensors. The ID value is going to be an alpha numeric character based string in order to avoid being restricted by a base 10 numbing system. With a base 10 system, a single character can only have 10 unique values (0,1,2,3,4,5,6,7,8,9). With a character based string, it can be 0-9+a-z, which gives a total of 36 unique values per character. In this manner, the controlling microprocessor is going to fetch about 21 values from the sensors for a given fit session. The straps give an analog value that is the sum of all the resistors in series for that circuit. By selecting the resistor values using different ranges of resistors being used, there does not need to be a separate character for each strap.

TABLE 3
Example resistor values in Arm Straps

| Strap | Resistor | Value (for example only) |
|---|---|---|
| Strap 3 | R7 | 100K |
| Strap 3 | R8 | 200K |
| Strap 3 | R9 | 400K |

TABLE 4
Calculated resistances for various Arm Strap positions

| Strap | Connected at position | Resulting resistance |
|---|---|---|
| 3 | G | R7 = 100K ohms |
| 3 | H | R7 + R8 = 300K ohms |
| 3 | I | R7 + R8 + R9 =700K ohms |

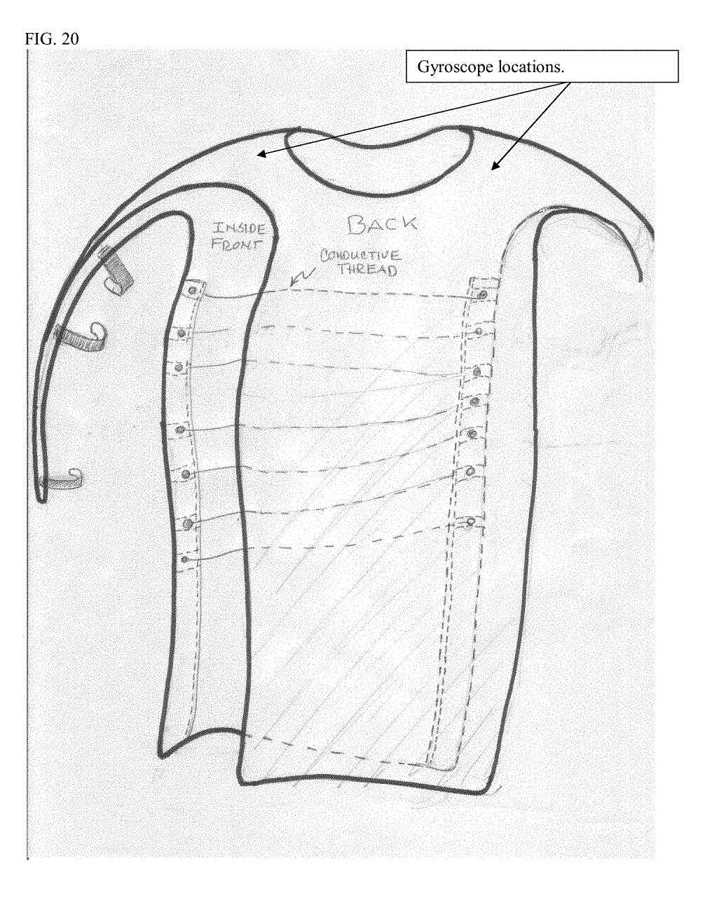

The Fiteema device may be constructed as two aprons—the front one is worn in the manner of an apron. The other one is worn backwards—i.e.: hanging down on the backside of the customer. The sides are completely open and attach to each other by a series of horizontal straps, which in the preferred embodiment are 7 per side. On the front piece, magnets are sewn into the garment from the inside and there is a piece of conductive thread going from the top magnet on the left side to the top magnet on the right side. This is repeated for all the straps (i.e.; magnet that is 2nd from the top on the left side is connected via conductive thread to the magnet which is second from the top on the right side). This is the same for all the magnets (see FIG. 20). In addition, Gyroscope sensors are sewn into Fiteema in the shoulder area to measure shoulder slope. In the preferred embodiment, the gyroscope is embodied in an electronic micro-chip about the size of a grain of rice, so its weight and size will not affect the wearer. The straps have washers sewn into them at about 1 inch intervals. The magnets will securely hold the strap were the Customer places it. The straps could have been buttons or Velcro, but the magnets and metal washers are used in the preferred embodiment so that it is fast and easy for the Customer.

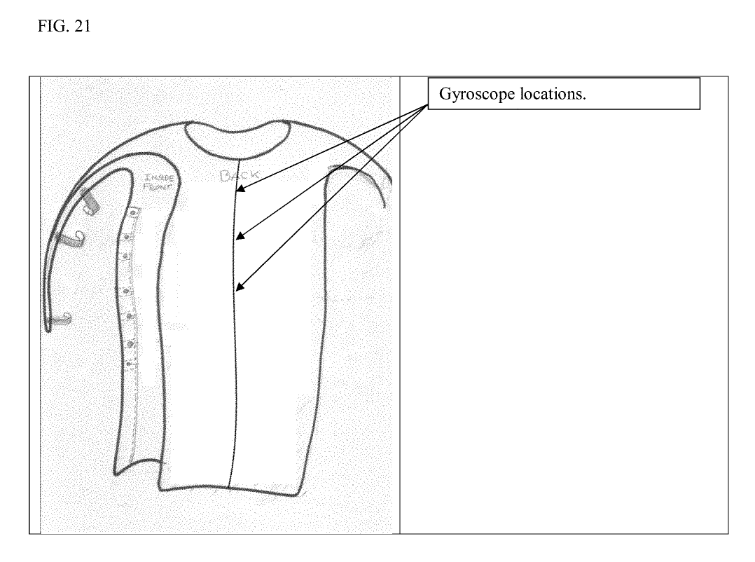

In order to measure the desired fit for the drape and fit in the back, more gyroscope are sewn in the back as shown in FIG. 21. The gyroscopes are preferably embodied in a micro-chip that is addressable by the computer controller. In this manner, the computer controller can poll the chip sensors for their orientations, and by means of the network or bus address used, the computer controller can update the database to indicate that orientation in each location on the Fiteema device that has a gyroscope sensor.

### Stage 2: Transcriber

Background: The Transcribing™ stage includes recording coordinates, in one embodiment the “X” and “Y” coordinates, that define each point on the pattern and assigns them names (in one embodiment naming is done according to the established Lab141 Manning Process naming convention standards) and entity types (for example, ‘line’, ‘curve’, ‘dart’, etc.). The output of Transcriber™ is stored in a relational database for each component of each garment for further use in creating a custom garment.

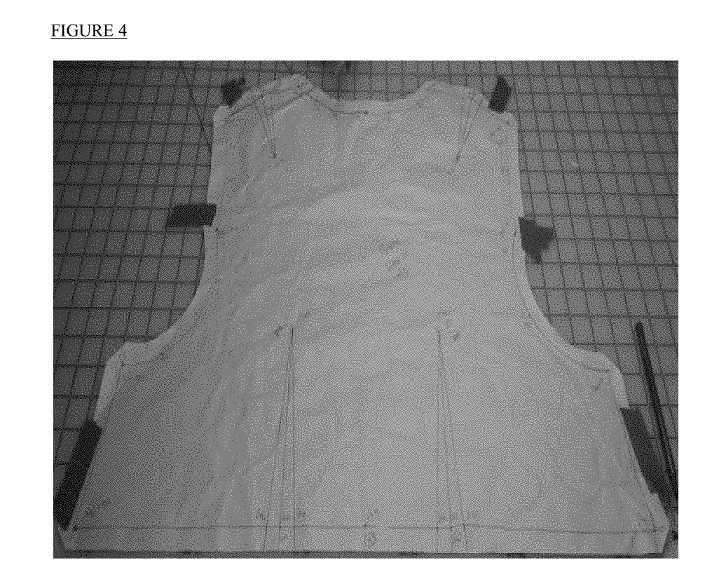

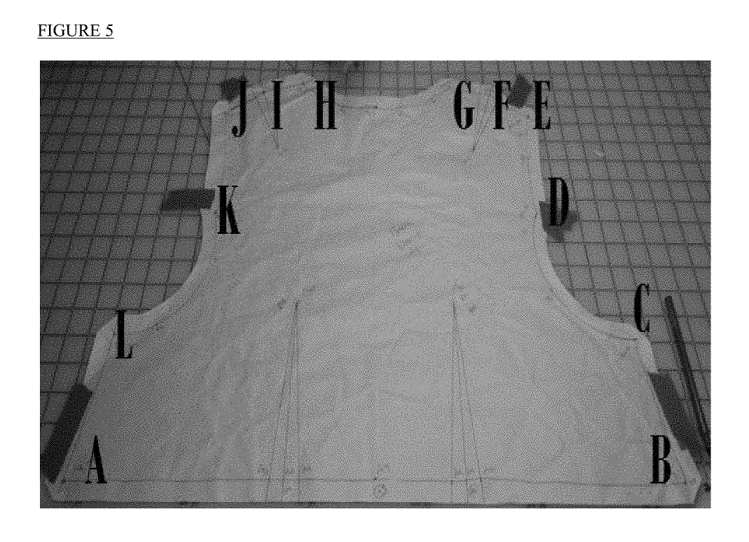

Operation: The Transcribing™ stage can be performed either electronically or manually. In one embodiment, the manual operation is performed by securing a pattern to a work surface and locating a touch probe digitizer (for example, the Microscribe™, Faro™, or Roland™) such that the stylus can reach every line on the pattern. The stylus gives the most accurate coordinates while being close ‘normal’ or perpendicular to the surface. The pattern is secured such that the item would be in its ‘expected’ position as if the garment was being worn (i.e.: the waist is horizontal and the neck would be at the top—see FIG. 4). FIG. 4 shows the top back component of a dress pattern. Starting at the lower left corner of the pattern, label the point ‘A’ and then moving counter clockwise continue alphabetically labeling the points (see FIG. 5).

In one embodiment, the Transcribing™ stage is only performed on the sewing lines and the dart lines. The cutting lines, which are concentric to the sewing lines, are calculated depending on the amount of seam allowance specified. For example, if the standard seam allowance of half an inch is desired, the cutting line is calculated that is offset ½ inch from the sewing line. The original size of the garment being digitized (size 8, 10 or 12, etc.) is irrelevant. Measurement or construction lines (such as those that record distance—‘ShoulderWidth’, etc.—are created in the Transcribing™ stage. Below are steps for one embodiment of the Transcribing™ stage.

In some The Transcribing™ stage simply records the “X” and “Y” coordinates that define each end points of the entities that comprise the pattern and assigns them names and entity types. For curves, the step transcribes the beginning and end point of the curve and determines parameters that define a function that approximates the curve. In the system, the curve is then represented in the data as the two points and the parameters. The output of the Digitized Design is stored in a relational database for each component of each garment for further use in creating a custom garment. In another embodiment, an entity is a curve, which can be represented in the data as a series of line segments.

Step 1) Each component (Dress upper back is shown in FIG. 4) of a paper pattern is secured to a work surface and digitized. All data is stored in a relational database for each point, for each component for each garment. The entire garment being digitized is composed of an upper back, upper front, lower back, lower front, left sleeve, right sleeve and collar. Each of these components would have to be digitized separately. The component ‘Dress upper back’ is shown in FIG. 4.

Step 2) Now meta data needs to be created for each entity. In one embodiment shown in FIG. 5, Points A and B form entity “MeasurementAB”. Metadata includes the value for ‘LineType’ (in this case is ‘measurement line’) and the value for ‘Description’ (in this case is ‘waist’). Similarly, Points C and L of FIG. 5 form entity “MeasurementCL”. Metadata includes the value for ‘LineType’ (in this case the value is ‘measurementline’) and the value for ‘Description’ (in this case is ‘bust’). Also, Points E and J of FIG. 5 form entity “Measurement EJ”. Metadata includes the value for ‘LineType’ (in this case the value is ‘measurementline’) and the value for ‘Description’ (in this case is ‘shoulder width’).

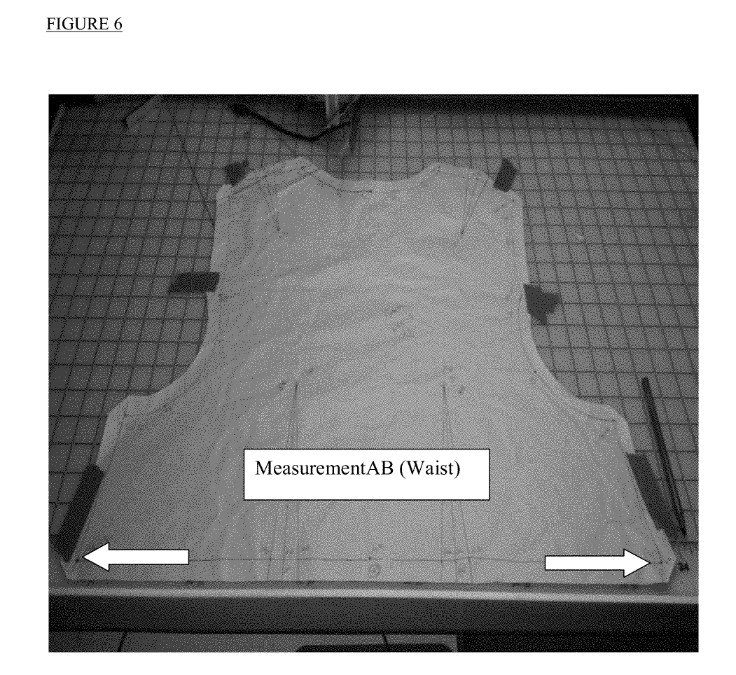

FIG. 6 shows the location of measurement lines in one embodiment. A linetype of ‘Line’ has only two points: The coordinates at the ‘beginning’ and the ‘end’. A linetype of ‘Curve’ can have many points, but requires at least 5. These points are the beginning and the end of the curve, then at least 3 points on the curve selected at random that are used to calculate the equation of the curve in Step 3. These points should include one near the middle of the curve.

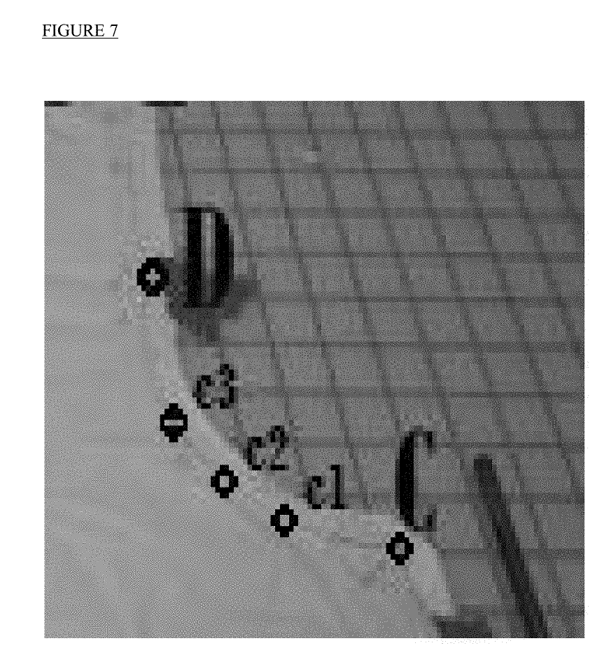

Step 3) Digitizing a curve requires that the lineType of ‘Curve’ is recorded. From FIG. 5 note that the beginning of the curve (point C) and the end of the curve (point D) has been recorded. To mathematically define the curve, three more data points on the curve are recorded (these points are labeled c1, c2 and c3—see FIG. 7) and the assumption is made that since it is a simple curve, that it can be represented by the quadratic equation:

f(x)=Ax̂2+Bx+C EQ 1

At this point there are 3 unknowns (A, B and C) and 5 equations (beginning point, end point and the three random points in the center just recorded). The simplest way to solve these equations for A, B and C is inverse matrix multiplication.

It is important to determining the equation that will closely represent the curve so that points can be calculated for a very small change in the X direction. For example, if you want to determine 100 points on that curve and you could create an X Y grid and increment the x value 0.1 inch and calculate the Y.

TABLE 5

| X | Y |
|---|---|
| 0.0 | * |
| 0.1 | * |
| 0.2 | * |
| 0.3 | * |
| . . . | . . . |

* The Y values are calculated using equation EQ1 above.

It is important to have a mathematical representation of the curve so that coordinates can be calculated at very small increments. Since the cutting wheel has a rotational preference, it must always be kept tangential to the curve it is cutting. If not, it can ‘drag’ along the fabric slightly and cause the fabric position to shift. This would result in the vacuum machine not cutting where it was expected and possibly cause the component to be unusable.

While some G-code allows for the definition of an arc, not all G-code interpreters follow all of the same standards. Therefore there is more control and universal acceptance in describing a curve as a series of very short discreet straight lines. This will allow for translation to other cutting machines a customer may want to use.

Step 4) The same procedure is followed for each component that makes up the finished garment. For certain patterns, the garment may have options, such as different neck lines. In that case, all options would have to be digitized as well. It is assumed a typical Brand will not have any options. For examples, if a Customer wants a BrandX garment that is pattern #xxxxx and the Designer created it with a round neck line, the Customer does not usually have the option of creating the dress with a V-neck.

Step 5) The digitized coordinates are entered in the database and identified by primary key PatternID that defines Brand and Model. Detail also includes metadata such as coordinates, point name, Line type and Entity type. These values are mapped to Customer fit preferences later in Stage 3.

It is important to note that two components in a garment may share an entity. For example, a two part dress may have an entity on the upper part of the dress that is the waist, along the bottom of that upper portion, and the same waist entity as part of the lower skirt component. These two entities much match since they are sewn together. They have to be identical, but they are not the same entity. They are identical in length, curvature and dart location, but they are two separate entities in the database.

Further detail of transcribing and encoding of entities is explained in Appendix 1 to this disclosure, attached hereto and incorporated herein.

### Stage 3: Harmonizer

The current art for resizing garments has two major flaws: 1) It assumes their creation of a fit model is actually representative of all the customers and 2) It involves a sizing system that assumes proportions are the same across all sizes. Clothing is developed for a fit model—a person or mannequin that the designer believes represents their Customers. Once that garment fits exactly the way the designer intended, it goes through an unnecessarily complex and antiquated grading method which has no industry established standards. Every brand has a different sizing system, sizes in one brand have no relationship to sizes in another brand and the net result is that multiple returns by consumers placing online orders are virtually guaranteed.

The Harmonizing™ stage brings together the SNIP™ generated in stage one and Transcriber™ data from stage two to map and generate G-code for the Vesti™ cutting table to produce custom components comprising the garment fit for the customer.

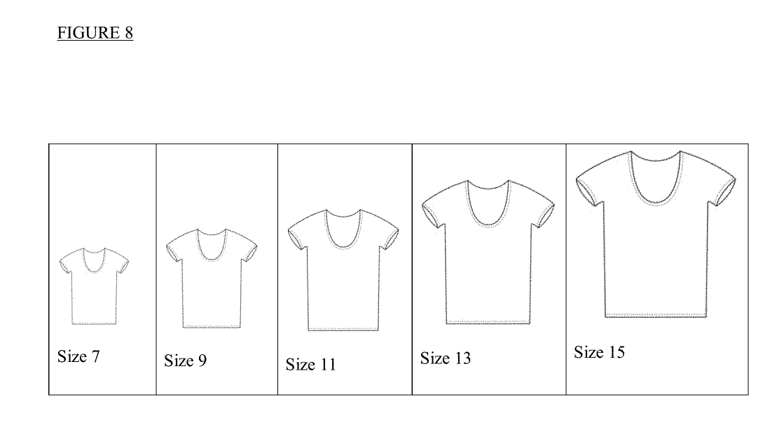

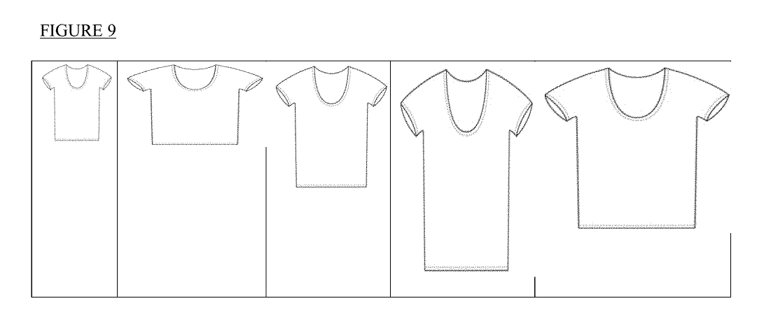

The current typical sizing system for garments is loosely based on geometric scaling (see FIG. 8). The Manning Process™ will dimension clothes for whatever size and shape that people require. See FIG. 9.

In one embodiment, the Harmonizer™ will query the garment database for the GarmentID being created and return all the components that make up the garment. All of the components have metadata that includes Measurement line names. The Harmonizer will set the measurement line values to the values recorded by the Fiteema process and re-dimension all the vectors in each component and generate the G-code to cut it out.

As a preliminary matter, in this description of the invention, an entity refers to a line in the pattern, typically comprising the outline that comprise the garment components. Some entities are visually apparent as part of the pattern, for example entity types that are a ‘line’, ‘curve’, ‘dart’, ‘seam’ or ‘cut’. In some cases, the cut is the seam allowance that is added to the dimension of where the seam is. In the invention other entities are construction lines, that is, they are dimensions implied by the geometry of the pattern. By way of explanation, the distance representing the bust-line of a blouse is a construction line, but is an important entity with regard to the fit of the blouse. So while the pattern itself may not cut the bust-line, its value is determined by the geometry of the blouse pattern, which may be defined by the perimeter entities that would be cut in order to make the blouse. The entities may be manipulated by the Harmonizer to adjust the fit of the garment for the customer.

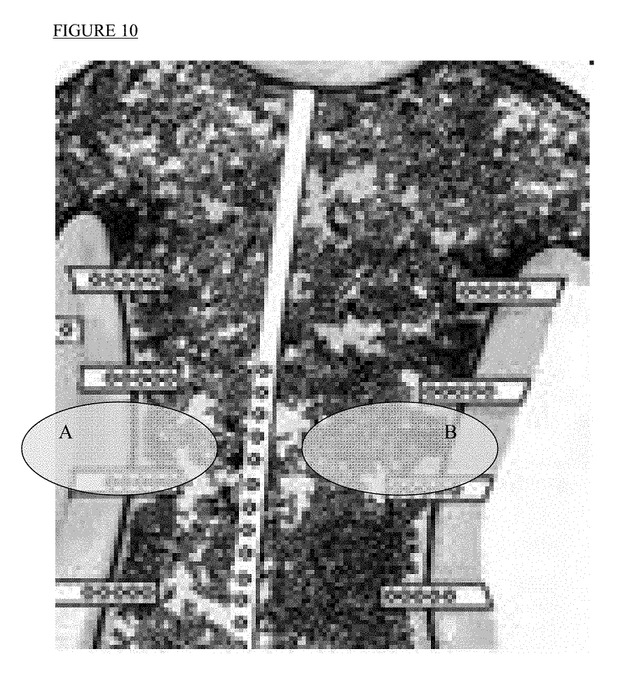

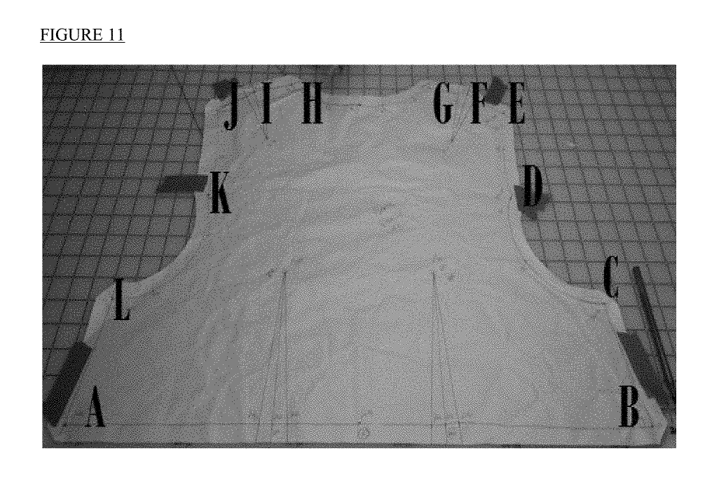

In one embodiment, as shown in FIG. 11, the x and y coordinates for each point are presented, as well as entity metadata such as linetype and name. The left and right sensors highlighted in yellow (A and B) in FIG. 10 have recorded coordinates and calculated entity measurementLineAB—which is the waist measurement. In FIG. 11, LineAB represents the waist measurement in the pattern. The Harmonizer™ will re-dimension the pattern with the value recorded by Fiteema™, re-dimension the pattern and generate the G-code that will cut the fabric on the cutting table.

The Harmonizer™ is the final step before the G-code that actually cuts out the garment is sent to the Vesti™ cutting machine. This is the last opportunity to pass additional information to Vesti™. Printing a barcode or a name on the fabric with Customer information to help reduce the possibility of components being mixed up should be done at this time. The GUI for the Harmonizer™ give options for both.

The Harmonizer™ also has a software based leveling system that will measure any slight variations in the z elevation of the cutting surface and raise or lower the cutting wheel while it is cutting material to maintain a constant downward pressure on the cutting surface.

The mapping performed by the Harmonizor is simply adjusting the two points that define an entity, typically a construction line entity so that the revised construction line matches the fit value of the same construction line measured off the customer with Fiteema. For example, a construction line that is the entity called the “waist” may be determined by two points at either side of a cut line on a garment. The Harmonizer adjusts the position of both endpoints so that the resulting construction line entity so defined matches the construction line measured by the Fiteema device. Because the entire set of entities comprising the garment are subject to this adjustment, the fabric is not stressed but rather then entire customer's body curve ends up being replicated thereby fitting the customer.

In another embodiment, the system makes the redimensioning to the entity, and then examines the neighboring entities and makes redimensioning in the same direction by adjusting the endpoints defining the neighboring entities so that they have a similar redimensioning but of a lesser magnitude. In one example, if the percentage change of the first entity redimensioning is reduced by a factor and applied to the neighboring entities. This factor can be a predetermined empirical value. This approach can be used to redimension arm holes. For example, if the entity that is a construction line from the waist to the neck line is redimensioned, the entities defining the arm holes for the components may be adjusted by a factor times the amount of the redimensioned waist-to-neck construction line.

Once the Harmonizer has completed processing the data, G-code is generated from the points resulting from re-dimensioning the garment. The G-code is generated and saved it to a ascii text file. In one embodiment, an Excel ™ file is created that has a column of X values and a column of Y values for each point on a given component for the garment. Here is a sample G-code file:

### Sample:

### G0 X0 Y0 Z10

### G0 X0.0000 Y0.0000 Z0.0000 R0.0000

### G0 X632.4000 Y0.0000 Z0.0000 R0.0000

. . .
end of sample file

For example, where the first point is (0,0) and labeled Point A and the next point is (632.4,0) and labeled Point B, line one just tells the cutting machine to go to the origin, or the point x=0, y=0. (G0 means ‘go to the following point’). It tells it to raise the cutting head 10 units in the Z axis so it doesn't touch the fabric. (Z10). The motor named R is the motor that controls the rotation of the cutting wheel. It always has to be tangential to a curve being cut or parallel to a straight line being cut.

It then reads each line from excel (see that Point A is (0,0)) and builds the line in file (G0 X0.0000 Y0.0000 Z0.0000 R0.0000). The G-code tells the machine to go there and lower the cutting head (Z=0) and since it is a straight line it does not have to rotate the cutting axis (R=0). Then the next line in Excel is read (632.4,0) and the cutting head is moved there while keeping the cutting head down and without rotating the cutting axis. That line in the G-code is: G0 X632.4000 Y0.0000 Z0.0000 R0.0000.

### Stage 4: Vesti

There are many advantages to Vesti™, a modular CNC cutting table with vacuum assisted hold down. The advantages include: Modular Construction, Self contained Gantry, Interchangable tool heads, Minimal noise level, Electrical consumption management, standard and adjustable Voltage requirements, Open source electronics, Industry standard machine language, and low cost.

Modular Construction: Using a standard chain drive mechanism to control gantry movement, Vesti™ can be expanded to nearly any length without completely switching the drive mechanism, but rather attaching extra lengths of chain and bolting on an extra vacuum table. In one embodiment, the standard table has a vacuum cutting area of approximately 45″ wide by 28″ deep. To create a larger cutting area, additional tables—identical to the original table but without the gantry, electronics and toolheads, can be purchased and bolted together to the first section.

Self contained Gantry: The gantry is a completely self contained component with all electronics and toolheads attached. This means that end stops switches will be incorporated into the gantry supports, unlike all other systems where the end stops are wired separately. This way, the gantry will keep moving until it either hits a block, or alternatively, the table owner can set the size of the table into the configuration file and the software setting will control it. This means there are no additional electronics to wire up. The supports can have either optical or mechanical end stops, but the operation is identical. The self contained gantry is an advantage because the user can simply keep attaching additional vacuum tables to get the work surface to the desired length and nothing else needs to installed or configured.

Interchangable tool heads: In one embodiment, the toolheads on the vacuum table can include:

1) A rotary cutting wheel that can pivot 360 degrees in either direction so that the cutting wheel is always moving in a tangential path to the curve being cut.

2) An inkjet print head so that fabric can be marked without ever touching it. This allows printing as fast as possible since there will be no shear force on the fabric that the vacuum would have to overcome. Speed is only determined by the current draw required for the stepper motors. A standard print cartridge can be used but there are also many other type inkjets available including electrically conductive and food safe for a variety of different products.

3) A stepper motor that would act as a drill (with speed limited to that of the stepper) that can be used to clean and maintain the holes in the vacuum surface. A standard collet would be installed so that the user can use the cutting table to make wooden signs and artwork. Since the drive is composed of a reinforced rubber belt, it would be limited to speed and depth of material being worked.

4) A holder that would fit a Cricut® or other commercially available personal cutting machines drag knife cutting blades for fine work.

5) A serrated wheel for marking stitching holes in leather or other durable fabrics as well as being used with marking paper to mark fabric.

6) A LED diode laser for engraving and cutting light fabric.

7) An optical scanner for digitizing patterns with a line follower program.

8) A pen or pencil for drafting to essentially create a horizontal plotter.

Minimal noise level: The commercially available vacuum (such as a ShopVac) is housed in a acoustically isolated cabinet to keep noise levels low. This will allow operation in sound sensitive locations and at normally quiet times as well as user serviceability. Whether nearby where conference calls are being conducted or in a spare bedroom late at night that could disturb neighbors, the cutting table is designed to be work around a variety of environments.

Electrical consumption management: Using Pulse width modulation (PWM) system to control current draw, the cutting table can be composed of several work tables without drawing enough current to trip a standard household 15 Amp circuit breaker.

Voltage requirements: The Lab141 was designed to operate on standard 120 volt current. The adjustable PWM circuit keeps current draw below a given current draw to prevent the tripping of circuit breakers.

Open source electronics: The electronic circuitry used to drive the stepper motors that control the cutting operation are all open source and User upgradable and maintainable.

Industry standard machine language: The electronic circuitry used to drive the stepper motors that control the cutting operation are all open source and User upgradable and maintainable.

Cost: By using commercially available vacuums (i.e.: Shopvac) and open source electronics (RAMPS 1.4, RAMPS 1.5.7, etc.), the machine is inexpensive and User maintainable. The two primary operations of the cutting table, cutting with the rotary wheel and marking with the inkjet head cannot be performed simultaneously since the two separate paths for each toolhead are not always the same. Certain movements could be coded to allow simultaneous operation to solve this problem, but the effort required for coding is probably not worth the small time savings in production. Especially since the two operations are performed at very different speeds. In addition to this, since the cutting wheel is in direct contact with the fabric and shifting of the fabric must be avoided at all costs, acceleration profiles for the cutting tool have been developed. On straight cuts, the operation is full speed, but the program ‘reads ahead’ and if a direction change or curve is coming up, the speed slows. After the more difficult cut, the cutting tool accelerates again as needed.

If a laser cutting toolhead is used, the complexity of the cut does not matter since the toolhead never touches the fabric. The cutting speed is limited to the lasers ability to cut the material. The print head is never in contact with the fabric, so it is set to go at full speed the entire time. Tight corners or complicated cuts will not have an impact at all.

### Procedure of One Embodiment

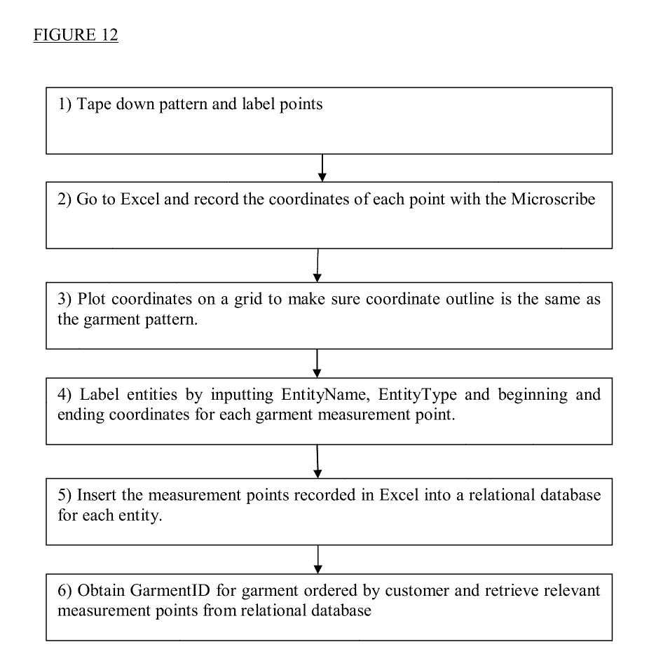

FIG. 12 shows a flowchart of the procedure of one embodiment of the invention. In one embodiment the steps include:

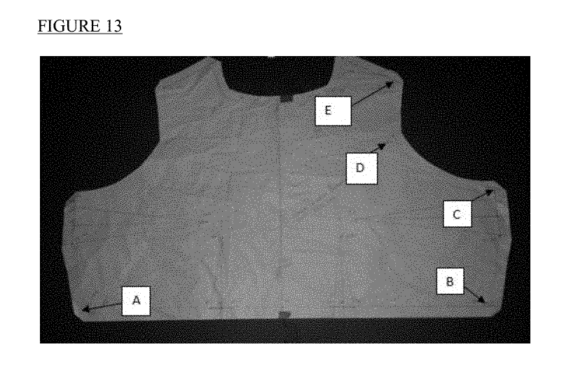

1) Tape down pattern and label points. See FIG. 13.

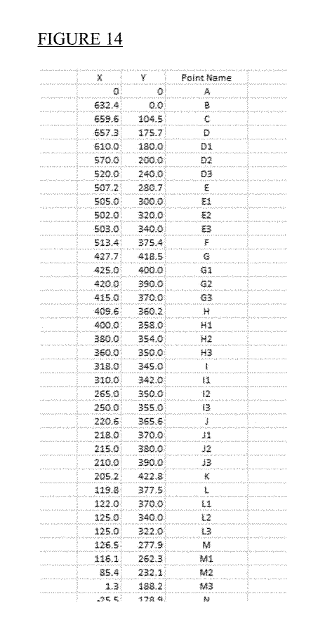

2) Go to Excel and record the coordinates of each point with the Microscribe. See FIG. 14.

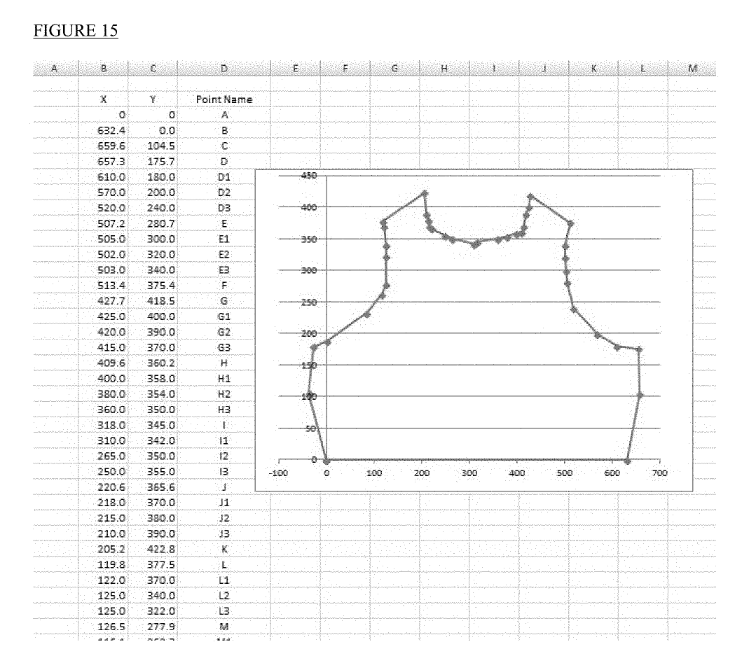

3) Plot the coordinates of each point on a grid to make sure outline is the same. See FIG. 15. Coordinates shown in step 2, FIG. 14 are for the sewing line only.

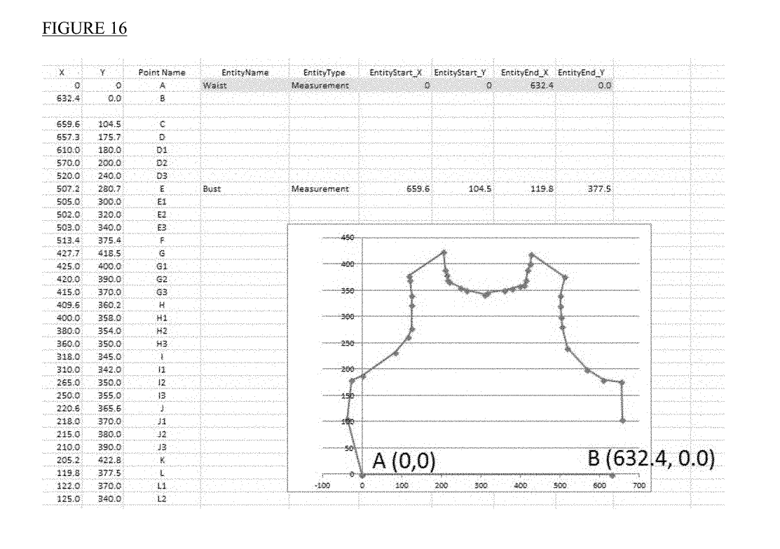

4) Label entities: EntityName, EntityType and beginning and ending coordinates for each point. In FIG. 16 the Entity named “Waist” is being defined: it starts at point A (with coordinates (0,0)—(see coordinates listed in step 2) and it ends at point B which has the coordinates (632.4,0)—we have now defined the Waist measurement entity for this part of this garment.

5) This same procedure is repeated for all the other measurement entities, such as ‘Bust’, ‘Hips’, ‘Shoulderwidth’, ‘Bicep’, etc.

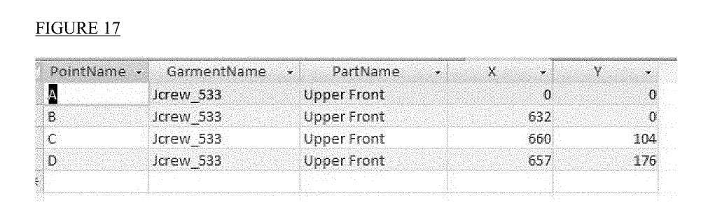

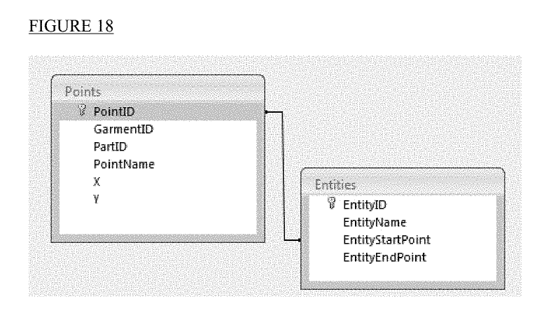

6) Insert the points recorded in Excel into the relational database: In one embodiment, see FIG. 17, the Point data goes in the table named “Points”. In FIG. 17, assume the Garment being worded on is called “FamousBrand_533” and the Partname being worked on is called “Upper Front”. Using SQL, these data may be inserted into the table, see FIG. 18 for an example of one table.

Now repeat for all the points for this part for this pattern.

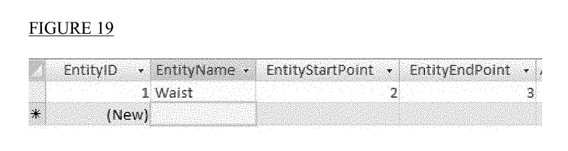

7) Now the system will insert all the Entity data. This is the data that is downloaded and manipulated for each customer to match their Fiteema value. The Entities all have a ‘Name’ and they have a starting point (which is already in the Points table) as well as an ending point (which is in the table also) (see FIG. 18). We just have to relate the entity to the existing PointID in the point table. Looking at the data in the Entity table, it only has one record in it for an entity called ‘Waist’ that starts at PointID2 and goes to PointID3. If we look at the Points table, we can see what garment and part this entity is for. See FIG. 19. Using SQL, we can walk down the list in Excel and insert all the entities into the Entity table very quickly. Now when a Customer orders a garment, we can get the GarmentID and see all the parts that make that up (all PartID values for that GarmentID value. We can easily retrieve all the points (PointID) that define that part and all the entities (EntityID for that GarmentID and PartID combination) that we need to adjust so it fits the customer perfectly.

All of the new points to redimension this garment are not saved since it is so easy to generate them again.

Once the components of the garment have been cut at the Vesti step, the components may be assembled together using typical garment assembly processes, including sewing the components together to form the custom-fit garment.

What is claimed:

1. A computerized method of manufacturing a customized fitted rendition of a garment comprised of a pre-existing design pattern, said pattern comprised of a plurality of design measurement location indices and a corresponding dimension value comprising:
receiving in a computer system a plurality of fit data from a corresponding plurality of sensors mounted on a fitting garment, each of said sensors corresponding to a fit measurement location index;
storing in the computer system the plurality of fit data in a corresponding plurality of corresponding data records, said data records further comprised of data representing fit measurement location indices that the fit data corresponds to;
using the received plurality of fit data to numerically transform the plurality of design measurement location indices and corresponding dimension values to generate a plurality of cut measurement location indices and corresponding dimension values.

2. The method of claim 1 further comprising:
numerically transforming at least one dimension value in a design measurement data that corresponds to an entity comprising the garment design by adjusting the location dimensions of a first and second endpoints points that define the entity so that a construction line defined by the first and second points matches the dimension value of the corresponding received fit data.

3. The method of claim 2 further comprising:
redimensioning in the same direction as the adjusted dimensions a third and fourth endpoints that define a neighboring entity so that the change to the transformed neighboring entity is by a lesser relative amount.

4. The method of claim 1 further comprising:
generating a plurality of G-code commands from the cut measurement values.

5. The method of claim 4 further comprising:
controlling movement of a fabric cutting device using the generated G-code commands.

6. A computer system for manufacturing a customized fitted rendition of a garment comprised of a pre-existing design pattern, said pattern comprised of a plurality of design measurement location indices and a corresponding dimension value comprising:
a module adapted by logic to receive a plurality of fit data from a corresponding plurality of sensors mounted on a fitting garment, each of said sensors corresponding to a fit measurement location index;
a module adapted by logic to store the plurality of fit data in a corresponding plurality of corresponding data records, said data records further comprised of data representing fit measurement location indices that the fit data corresponds to;
a module adapted by logic to use the received plurality of fit data to numerically transform the plurality of design measurement location indices and corresponding dimension values to generate a plurality of cut measurement location indices and corresponding dimension values;
a module adapted by logic to control movement of a fabric cutting device using the plurality of cut measurement location indices and corresponding dimension values.

7. The system of claim 6 further comprising:
a module adapted by logic to numerically transform at least one dimension value in a design measurement data that corresponds to an entity comprising the garment design by adjusting the location dimensions of a first and second endpoints points that define the entity so that a construction line defined by the first and second points matches the dimension value of the corresponding received fit data.

8. The system of claim 7 further comprising:
a module adapted by logic to redimension in the same direction as the adjusted dimensions a third and fourth endpoints that define a neighboring entity so that the change to the transformed neighboring entity is by a lesser relative amount.

9. The system of claim 6 further comprising:
a module adapted by logic to generate a plurality of G-code commands from the cut measurement values.

10. The system of claim 9 further comprising:
a module adapted by lofic to control movement of a fabric cutting device using the generated G-code commands.

11. A device for electronically measuring a plurality of fit data comprising:
a garment comprised of a fabric, said garment comprised of a plurality of dimension sensors mounted at predetermined locations on the garment;
a computer adapted by logic to operatively connect to the plurality of dimension sensors said computer to address each of the sensors in order to obtain and store in memory a corresponding plurality of measurement values from the addressed plurality of sensors.

12. The device of claim 11 where the dimension sensor is comprised of a variable length strap that exhibits a variable resistance in dependence on the length of the variable strap.

13. The device of claim 12 where the variable resistance is obtained by a set of predetermined resistors in a series circuit, with at least one node corresponding to at least one conducting end point, whereby the resistance of the strap is determined by the selection of which conducting node is connected to an opposing circuit element.

14. The device of claim 12 where the predetermined resistors are selected so that the range of resistance for any one of the plurality of straps is distinct and constitutes a mode of addressing the individual strap measurements.

15. The device of claim 11 where at least one of the plurality of sensors is a capacitive sensor.

16. The device of claim 11 where at least one of the plurality of sensors is a gyroscopic sensor.
